(19) United States
(12) Patent Application Publication
(10) Pub. No.: US 2023/0007485 A1
(43) Pub. Date: Jan. 5, 2023

(54) SYSTEMS AND METHODS FOR NETWORK ANOMALIES MANAGEMENT

(71) Applicant: AT&T Mobility II LLC, Atlanta, GA (US)

(72) Inventor: Arturo Maria, Bellevue, WA (US)

(73) Assignee: AT&T Mobility II LLC, Atlanta, GA (US)

(21) Appl. No.: 17/364,228

(22) Filed: Jun. 30, 2021

(51) Int. Cl. H04W 12/088; H04W 12/122; H04W 88/16

(52) U.S. Cl. CPC H04W 12/088; H04W 12/122; H04W 88/16

(57) ABSTRACT

Aspects of the subject disclosure may include, for example, obtaining first data from a first gateway device located at a first location, the first gateway device having had first network traffic pass therethrough, the first data having been generated by a first user plane function that is operative on the first gateway device, the first data being indicative of a first network traffic anomaly associated with the first network traffic that had passed through the first gateway device, and the first network traffic anomaly having been detected by the first user plane function; determining via a control plane function, based at least in part upon the first data, whether a corrective action should be taken as a result of the first network traffic anomaly that is indicated by the first data, the determining resulting in a determination; and responsive to the determination being that the corrective action should be taken as the result of the first network traffic anomaly that is indicated by the first data, sending via the control plane function an instruction to the first user plane function, the instruction that is sent to the first user plane function instructing the first user plane function to take the corrective action with respect to the first network traffic anomaly. Other embodiments are disclosed.

### FIELD OF THE DISCLOSURE

The subject disclosure relates to systems and methods for network anomalies management.

### BACKGROUND

Anomaly detection is a technique which is used in networks to identify events which are not normal or represent a threat to an environment. For example, there are conventional commercial products such as DARK TRACE and CISCO firewalls which implement software clients to identify departure from normal network behavior (such clients can run, for example, on various servers communicating with the network). Identifying such anomalies is useful in determining whether there is a malicious actor in the network or if the network is malfunctioning.

There are two basic approaches in the telecom market to anomaly detection. One approach involves (as mentioned above) software clients which detect abnormal network activity and report to a central manager. Another approach monitors activity in the network without a client. In this latter approach, physically dedicated hardware (e.g., hardware probes inside the network) can be located in front of one or more servers and/or at one or more points of entry into the network. Also, in this latter approach, a baseline of activity for each node is developed and alerts are generated when anomalies or abnormalities are detected.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (which can function fully or partially within the communication network of FIG. 1) in accordance with various aspects described herein.

FIG. 2B is a block diagram illustrating an example, non-limiting embodiment of a system (which can function fully or partially within the communication network of FIG. 1) in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for anomalies management in a network. In one example, a network anomalies manager that operates in the context of a 5G (5^{th} Generation) network is provided. In one example, a network anomalies manager that operates in the context a 5G CUPS (Control User Plane Separation) network is provided. Other embodiments are described in the subject disclosure.

One or more aspects of the subject disclosure include an Anomalies Detection Manager (sometimes referred to herein as “ADM”) that operates via use of a UPF (User Plane Function).

One or more aspects of the subject disclosure include an Anomalies Detection Manager that operates via communication with a UPF.

One or more aspects of the subject disclosure include an Anomalies Detection Manager that can combine network monitoring and client-based monitoring with additional capabilities to dynamically repair and/or replace one or more affected user plane gateways.

One or more aspects of the subject disclosure include a control plane Anomalies Detection Manager (sometimes referred to herein as “c-ADM”) that can have the ability to interface with one or more external multi-operator core networks to determine whether the behavior observed is truly abnormal (such observation(s) can be used as a baseline (or as another baseline) for determining appropriate action).

One or more aspects of the subject disclosure include communications between a UPF that operates in a user plane and a centralized gateway that operates in a control plane.

One or more aspects of the subject disclosure include an approach of having a c-ADM manage the creation of monitoring and reporting elements of a UPF (e.g., a gateway UPF).

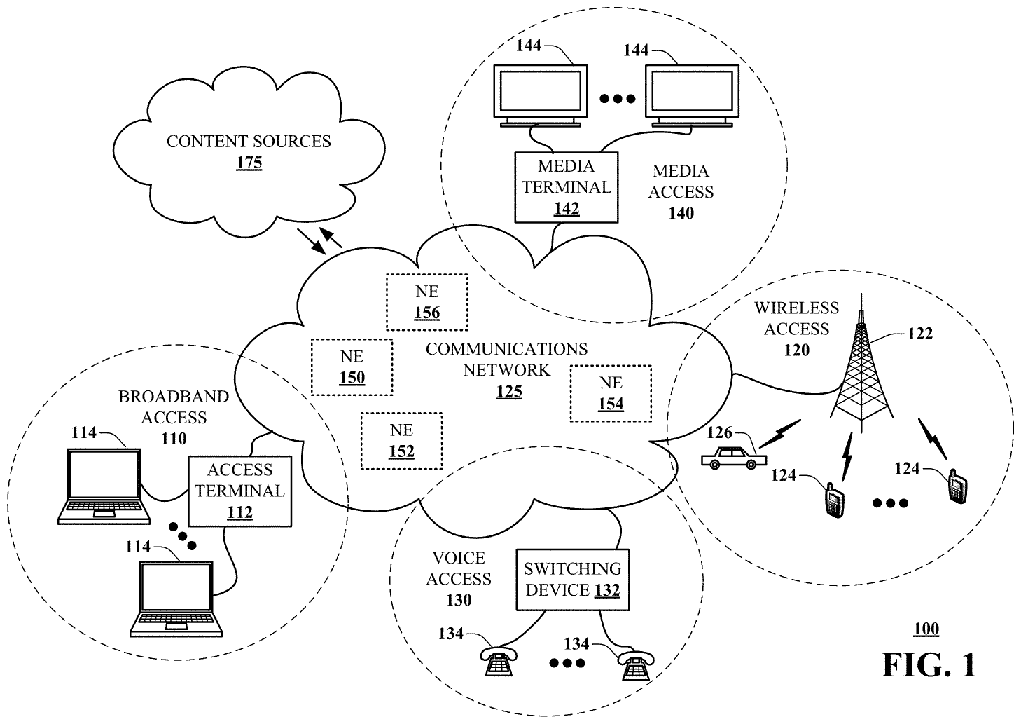

Referring now to FIG. 1, a block diagram is shown illustrating an example, non-limiting embodiment of a system 100 in accordance with various aspects described herein. For example, system 100 can facilitate in whole or in part network anomalies management (e.g., network anomalies detection and/or repair). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

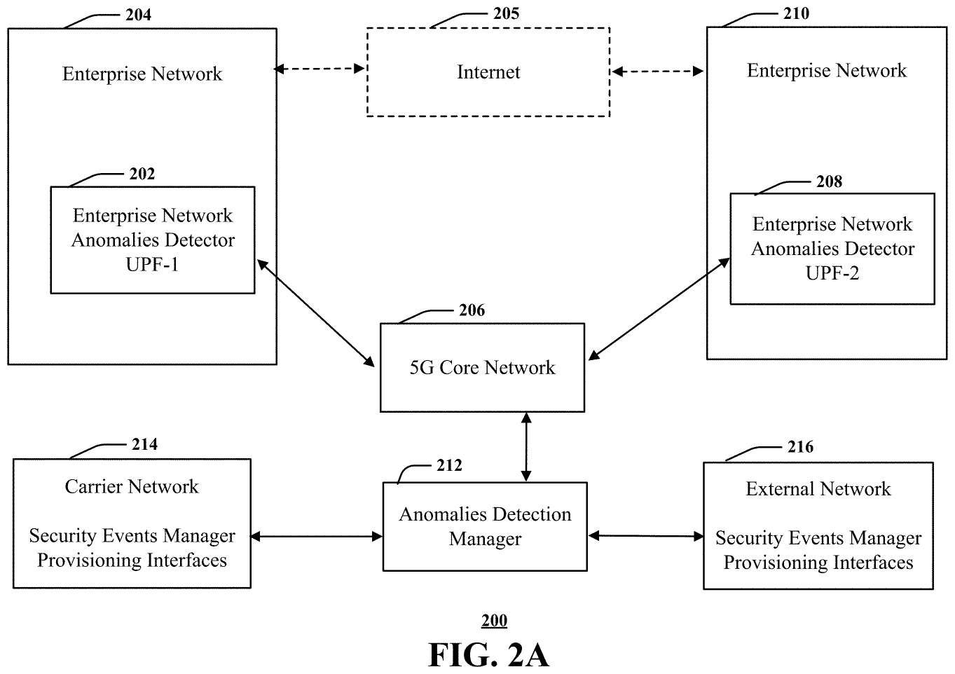

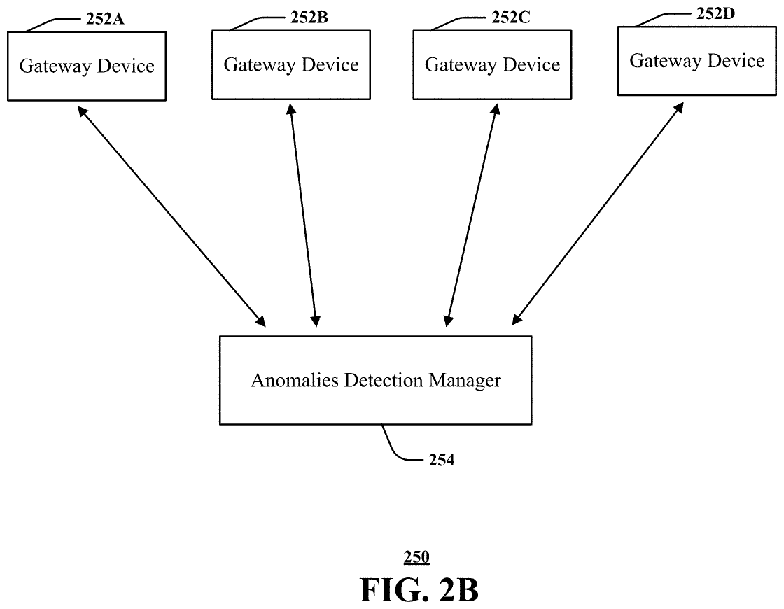

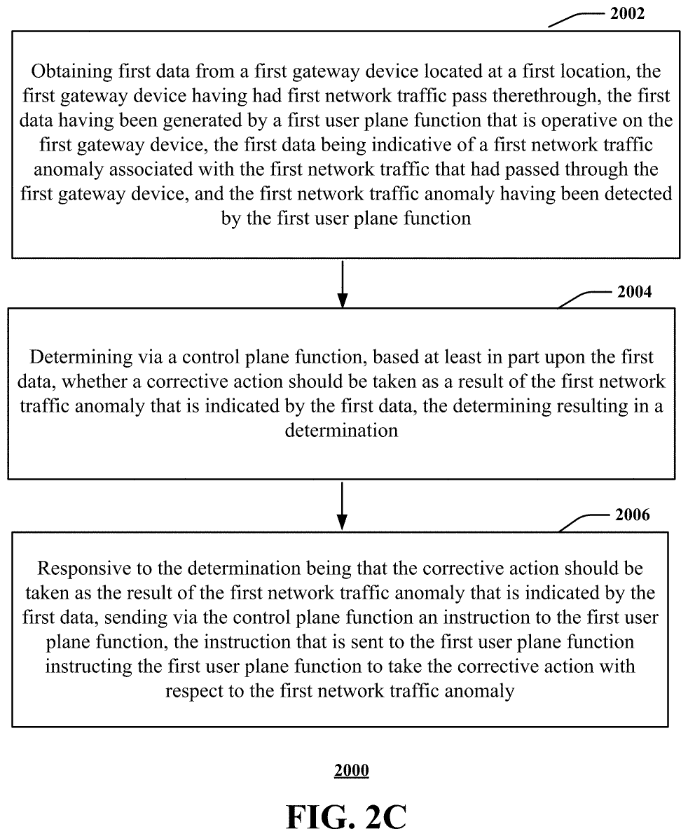

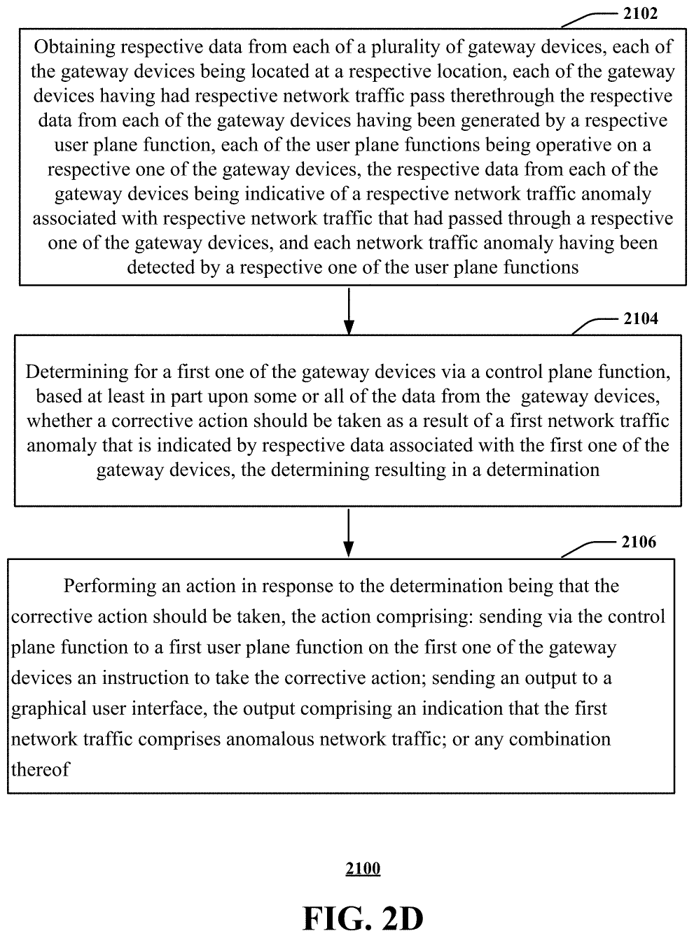

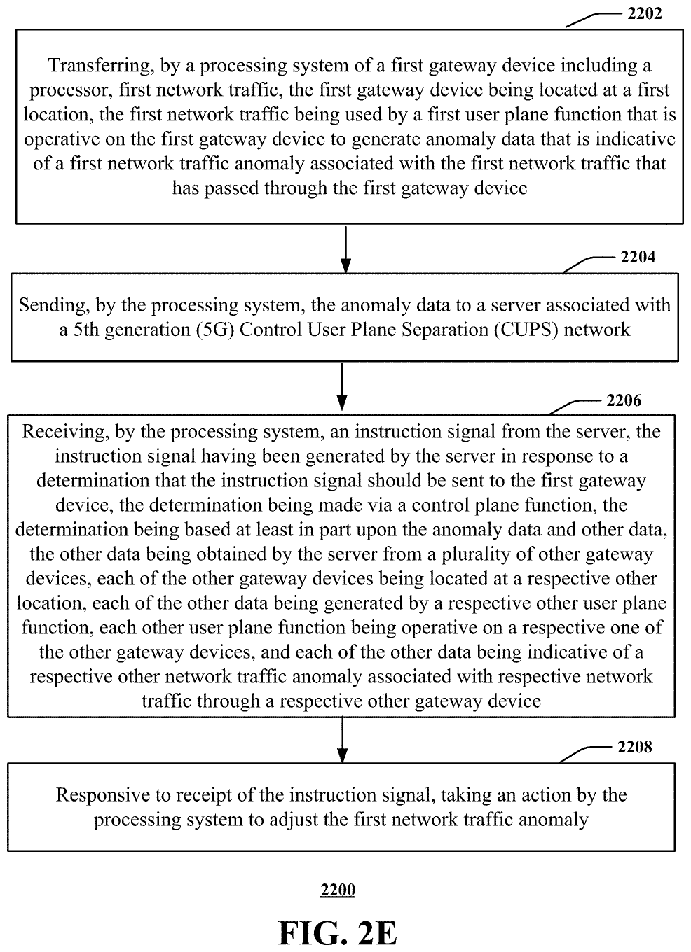

Referring now to FIG. 2A, this is a block diagram illustrating an example, non-limiting embodiment of a system 200 (which can function fully or partially within the communication network of FIG. 1) in accordance with various aspects described herein. As seen, an Enterprise Network Anomalies Detector UPF-1 202 is part of Enterprise Network 204 (in another example, Enterprise Network Anomalies Detector UPF-1 202 is separate from, and in bi-directional communication with, Enterprise Network 204). Further, Enterprise Network Anomalies Detector UPF-1 202 is in bi-directional communication with 5G Core Network 206. In various examples, the bi-directional communication between Enterprise Network Anomalies Detector UPF-1 202 and 5G Core Network 206 can be wireless, wired, or any combination thereof. In other examples, the Enterprise Network Anomalies Detector UPF-1 202 can communicate with (and/or be used by) other communication system(s) that are not 5G. In one specific example, the Enterprise Network Anomalies Detector UPF-1 202 can communicate in a backward compatible mode with one or more 4G S-Gateways. In other specific examples, in future releases, the Enterprise Network Anomalies Detector UPF-1 202 can communicate with other gateways and/or network elements—for instance, 6G, 7G, etc.

Still referring to FIG. 2A, Enterprise Network Anomalies Detector UPF-2 208 is part of Enterprise Network 210 (in another example, Enterprise Network Anomalies Detector UPF-2 208 is separate from, and in bi-directional communication with, Enterprise Network 210). Further, Enterprise Network Anomalies Detector UPF-2 208 is in bi-directional communication with 5G Core Network 206. In various examples, the bi-directional communication between Enterprise Network Anomalies Detector UPF-2 208 and 5G Core Network 206 can be wireless, wired, or any combination thereof. In other examples, the Enterprise Network Anomalies Detector UPF-2 208 can communicate with (and/or be used by) other communication system(s) that are not 5G. In one specific example, the Enterprise Network Anomalies Detector UPF-2 208 can communicate in a backward compatible mode with one or more 4G S-Gateways. In other specific examples, in future releases, the Enterprise Network Anomalies Detector UPF-2 208 can communicate with other gateways and/or network elements—for instance, 6G, 7G, etc. Further still, Enterprise Network 210 and/or Enterprise Network 204 can be in bi-directional communication with Internet 205. In various examples, the bi-directional communication between Enterprise Network 210/Enterprise Network 204 and Internet 205 can be wireless, wired, or any combination thereof.

Still referring to FIG. 2A, 5G Core Network 206 is in bi-directional communication with Anomalies Detection Manager 212 (which can comprise, for example, one or more servers). In various examples, the bi-directional communication between 5G Core Network 206 and Anomalies Detection Manager 212 can be wireless, wired, or any combination thereof. In another example, Anomalies detection Manager 212 can be part of 5G Core Network 206. Further, Anomalies Detection Manager 212 is in bi-directional communication with Carrier Network 214 (which can comprise, for example, one or more Security Events Managers and one or more Provisioning Interfaces). In various examples, the bi-directional communication between Anomalies Detection Manager 212 and Carrier Network 214 can be wireless, wired, or any combination thereof. In another example, Anomalies Detection Manager 212 can be in communication with a plurality of Carrier Networks (each of which can be, for example, a nationwide carrier such as AT&T). Further still, Anomalies Detection Manager 212 is in bi-directional communication with External Network 216 (which can comprise, for example, one or more Security Events Managers and one or more Provisioning Interfaces). In various examples, the bi-directional communication between Anomalies Detection Manager 212 and External Network 216 can be wireless, wired, or any combination thereof. In another example, Anomalies Detection Manager 212 can be in communication with a plurality of Eternal Networks (each of which can be, for example, a cloud service provider such as GOOGLE or MICROSOFT).

Still referring to FIG. 2A, in operation, Enterprise Network Anomalies Detector UPF-1 202 can detect one or more anomalies occurring (and/or that have occurred) in connection with one or more devices (not shown) operative on Enterprise Network 204. In various examples, the one or more devices operative on Enterprise Network 204 can comprise smartphone(s), cell phone(s), tablet(s), laptop computer(s), desktop computer(s), or any combination thereof. After detecting such one or more anomalies, the Enterprise Network Anomalies Detector UPF-1 202 can inform (e.g., via 5G Core Network 206) the Anomalies Detection Manager 212. In various examples, the Enterprise Network Anomalies Detector UPF-1 202 can inform the Anomalies Detection Manager 212 of such one or more anomalies via information message(s) or the like. The Anomalies Detection Manager 212 can then (e.g., responsive to the information message(s)) inform the Carrier Network 214 and/or External network 216 of such one or more anomalies. In addition (or in the alternative), the Anomalies Detection Manager 212 can (e.g., responsive to the information message(s)) instruct the Enterprise Network Anomalies Detector UPF-1 202 to take corrective action.

Still referring to FIG. 2A, in operation, Enterprise Network Anomalies Detector UPF-2 208 can detect one or more anomalies occurring (and/or that have occurred) in connection with one or more devices (not shown) operative on Enterprise Network 210. In various examples, the one or more devices operative on Enterprise Network 210 can comprise smartphone(s), cell phone(s), tablet(s), laptop computer(s), desktop computer(s), or any combination thereof. After detecting such one or more anomalies, the Enterprise Network Anomalies Detector UPF-2 208 can inform (e.g., via 5G Core Network 206) the Anomalies Detection Manager 212. In various examples, the Enterprise Network Anomalies Detector UPF-2 208 can inform the Anomalies Detection Manager 212 of such one or more anomalies via information message(s) or the like. The Anomalies Detection Manager 212 can then (e.g., responsive to the information message(s)) inform the Carrier Network 214 and/or the External Network 216 of such one or more anomalies. In addition (or in the alternative), the Anomalies Detection Manager 212 can (e.g., responsive to the information message(s)) instruct the Enterprise Network Anomalies Detector UPF-2 208 to take corrective action.

As described herein, in various embodiments a plurality of UPFs (User Plane Functions) are distributed (see e.g., elements 202 and 208 of FIG. 2A) and each of the UPFs communicates with a centralized gateway (see, e.g., elements 206 and 212 of FIG. 2A) In one example, data is routed from a Session Management Function (SMF) of a 5G core network (see, e.g., element 506 of FIG. 2A) to each respective UPF. In another example, the traffic would flow as defined by the 3GPP standards from the SMF to the UPF. In another example, the SMF would interface with an Anomalies Detector Manager (see, e.g., elements 206 and 212 of FIG. 2A).

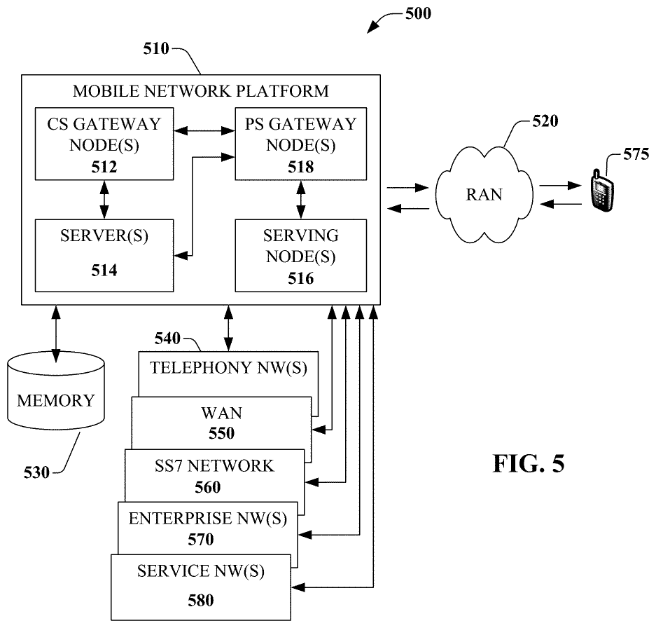

Reference will now be made to a system according to an embodiment that can operate as follows: (1) One or more UPFs is generated and configured. In one example, each UPF (sometimes referred to herein as a network virtual function (NVF)) can be generated and configured by a provisioning interface (see, e.g., the provisioning interface of element 214 of FIG. 2A and/or the provisioning interface of element 216 of FIG. 2A). (2) Each network virtual function can be provided to (and reside in) a respective end user enterprise premises (see, e.g., the enterprise network 204 of FIG. 2A and/or the enterprise network 210 of FIG. 2A) or a home. (3) Each UPF can have a front end called a Network Anomalies Detector (sometimes referred to herein as NAD). (4) Each NAD can be a tightly coupled NVF virtual function. (5) Each UPF can communicate with a control plane Anomalies Detection Manager (c-ADM) residing in (or otherwise in communication with) the carrier core network (see, e.g., Anomalies Detection Manager 212 of FIG. 2A and 5G Core Network 206 of FIG. 2A). (6) Each UPF can inspect traffic flowing through its respective UPF gateway (see, e.g., the UPF-1 202 of FIG. 2A and/or the UPF-2 208 of FIG. 2A). (7) Each UPF (see, e.g., the UPF-1 202 of FIG. 2A and/or the UPF-2 208 of FIG. 2A) can establish a respective baseline of what it considers normal behavior. (8) In one example, normal behavior can be defined as traffic that conforms to network expectations and is consistent with a historical pattern. (9) In one specific example, each UPF looks at traffic that occurs over a 1-week period of time. This traffic can include network protocols, IP addresses etc. This traffic can then be considered a baseline of behavior for the particular UPF. (10) If a given UPF detects behavior which is outside of its baseline, the core network ADM is alerted by that UPF. (11) The ADM reports the anomaly to a security event manager database (see, e.g., the security events manager of Carrier Network 214 of FIG. 2A and/or the security events manager of External Network 216 of FIG. 2A). (13) The ADM residing in (or otherwise in communication with) the core can have an external provisioning gateway for end-user configuration.

In another example, prior to the reporting of the one or more anomalies by the ADM to the security event manager database in step (11) above, the ADM can compare the one or more anomalies reported by given UPF with pre-provisioned profile(s) defining what is normal for a user plane function gateway (then, based upon this comparison, the ADM can decide whether or not to carry out step (11)).

In another example (which can replace or operate together with steps (6)-(10) above), the c-ADM can inspect the traffic, create a baseline, and/or determine abnormal behavior. For instance, the c-ADM centralized core function can inspect traffic flowing through one or more UPF gateways (see, e.g., the UPF-1 202 of FIG. 2A and/or the UPF-2 208 of FIG. 2A) and based upon this the c-ADM centralized core function can establish a baseline of what it considers normal behavior.

In one specific example: An enterprise can deploy a UPF gateway function (the gateway of this example routes traffic from a manufacturing facility to a cloud services provider such as MICROSOFT AZURE). The NAD detects anomalies and that affect performance since abnormal amounts of data are being transferred. The NAD reports these anomalies to the core c-ADM. The UPF gateway function is then reconfigured to prevent these anomalies and security event databases are updated.

In one specific example: A home has a 5G network deployed with a UPF gateway to route traffic directly to the Internet instead of to the core carrier network. The UPF of this example is also connected to the carrier core for control purposes. The UPF detects unusual amounts of traffic flowing through the home network. The UPF also detects traffic which are not consistent with previous baselines of behavior. The NAD software residing in the UPF alerts the c-ADM residing in the core. The home UPF is reconfigured dynamically. The anomalies are reported to the Security Events database.

In one specific example: The core c-ADM control function determines that a change of network behavior is expected for a particular UPF user plane gateway. The core c-ADM alerts the UPF of the change in behavior expected. The anomalies baseline is updated. No action is taken.

In one specific example: A UPF is configured to transmit video from a home or an enterprise location. The UPF NAD determines that video data is being transmitted to Internet Protocol addresses (IPs) which are outside of the normal baseline. The NAD alerts the core c-ADM. The core c-ADM manager records and alerts security databases of the anomaly. Depending upon the provisioning database, the core c-ADM instructs the UPF gateway to stop video transmissions to the suspicious IP address(es) or to continue to allow and gather reporting data.

Referring now to FIG. 2B, this is a block diagram illustrating an example, non-limiting embodiment of a system 250 (which can function fully or partially within the communication network of FIG. 1) in accordance with various aspects described herein. As seen, a plurality of gateway devices 252A, 252B, 252C, 252D are in bi-directional communication with Anomalies Detection Manager 254 (while four gateway devices are shown in this example, any desired number of gateway devices can be utilized). In one example, each of the gateway devices 252A, 252B, 252C, 252D is configured to run thereon one or more user plane functions to carry out various functions (e.g., anomaly detection and/or repair) as described herein. In various examples, the bi-directional communication between each of gateway devices 252A, 252B, 252C, 252D and Anomalies Detection Manager 254 can be wireless, wired, or any combination thereof. In various examples, each of gateway devices 252A, 252B, 252C, 252D can be configured for communication with a respective enterprise network (not shown). In various examples, each of gateway devices 252A, 252B, 252C, 252D can be part of a respective enterprise network (not shown). In one example, Anomalies Detection Manager 254 can be part of a 5G Core Network (not shown). In one example, Anomalies Detection Manager 254 can be in bi-directional communication with 5G Core Network (not shown). In one example, Anomalies Detection Manager 254 is configured to run thereon one or more control plane functions to carry out various functions (e.g., anomaly detection and/or repair) as described herein.

Referring now to FIG. 2C, various steps of a method 2000 according to an embodiment are shown. As seen in this FIG. 2C, step 2002 comprises obtaining first data from a first gateway device located at a first location, the first gateway device having had first network traffic pass therethrough, the first data having been generated by a first user plane function that is operative on the first gateway device, the first data being indicative of a first network traffic anomaly associated with the first network traffic that had passed through the first gateway device, and the first network traffic anomaly having been detected by the first user plane function. Next, step 2004 comprises determining via a control plane function, based at least in part upon the first data, whether a corrective action should be taken as a result of the first network traffic anomaly that is indicated by the first data, the determining resulting in a determination. Next step 2006 comprises responsive to the determination being that the corrective action should be taken as the result of the first network traffic anomaly that is indicated by the first data, sending via the control plane function an instruction to the first user plane function, the instruction that is sent to the first user plane function instructing the first user plane function to take the corrective action with respect to the first network traffic anomaly. In other embodiments, one or more of the steps is only done by (and/or at) one or more gateways.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, a gateway (or a gateway device) can be a network element that translates data traffic from one protocol to another. In various examples, such translation can be from layer 1 or layer 2 protocols to IP. In another example, such translation can be from IP to UDP. A network element may not need to translate protocols. For example, if the traffic is not exiting the 5G Core, then protocol translation may not be necessary. Thus, a network element may be a gateway (or a gateway device) but not all network elements are required to be gateways (or gateway devices).

Referring now to FIG. 2D, various steps of a method 2100 according to an embodiment are shown. As seen in this FIG. 2D, step 2102 comprises obtaining respective data from each of a plurality of gateway devices, each of the gateway devices being located at a respective location, each of the gateway devices having had respective network traffic pass therethrough the respective data from each of the gateway devices having been generated by a respective user plane function, each of the user plane functions being operative on a respective one of the gateway devices, the respective data from each of the gateway devices being indicative of a respective network traffic anomaly associated with respective network traffic that had passed through a respective one of the gateway devices, and each network traffic anomaly having been detected by a respective one of the user plane functions. Next, step 2104 comprises determining for a first one of the gateway devices via a control plane function, based at least in part upon some or all of the data from the gateway devices, whether a corrective action should be taken as a result of a first network traffic anomaly that is indicated by respective data associated with the first one of the gateway devices, the determining resulting in a determination. Next, step 2106 comprises performing an action in response to the determination being that the corrective action should be taken, the action comprising: sending via the control plane function to a first user plane function on the first gateway device an instruction to take the corrective action; sending an output to a graphical user interface, the output comprising an indication that the first network traffic comprises anomalous network traffic; or any combination thereof.

In various examples, the corrective action can comprise: (a) Dynamically re-configuring the first gateway device (and/or one or more other user devices) to address (e.g., minimize or eliminate) the anomalous network traffic (in one specific example, the corrective action can comprise prohibiting Internet access for a machine that is connected wirelessly; in one specific example, the corrective action can comprise prohibiting Internet access for a modem that is hardwired); (b) Cutting off network access to and/or from the first gateway device (and/or one or more other user devices); (c) Restricting throughput (e.g., amount of data) to and/or from the first gateway device (and/or one or more other user devices); (d) Cutting off network access to and/or from a particular Internet Protocol (IP) address; and/or (e) Restricting throughput (e.g., amount of data) to and/or from a particular Internet Protocol (IP) address.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2200 according to an embodiment are shown. As seen in this FIG. 2E, step 2202 comprises obtaining, by a processing system of a first gateway device including a processor, first data, the first gateway device being located at a first location, the first data being generated by a first user plane function that is operative on the first gateway device, the first data being indicative of a first network traffic anomaly associated with first network traffic that has passed through the first gateway device. Next, step 2204 comprises sending, by the processing system, the first data to a server associated with a 5th generation (5G) Control User Plane Separation (CUPS) network. Next, step 2206 comprises receiving, by the processing system, an instruction signal from the server, the instruction signal having been generated by the server in response to a determination that the instruction signal should be sent to the first gateway device, the determination being made via a control plane function, the determination being based at least in part upon the first data and other data, the other data being obtained by the server from a plurality of other gateway devices, each of the other gateway devices being located at a respective other location, each of the other data being generated by a respective other user plane function, each other user plane function being operative on a respective one of the other gateway devices, and each of the other data being indicative of a respective other network traffic anomaly associated with respective network traffic through a respective other gateway device. Next, step 2208 comprises responsive to receipt of the instruction signal, taking an action by the processing system to adjust the first network traffic anomaly.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments can provide systems and methods for network anomalies management. In various examples, the network anomalies management can comprise detection and/or repair.

As described herein, various embodiments can provide for an Anomalies Detection Manager (ADM) in a 5G CUPS network. In various examples, an ADM can reside in the 5G Core at the Control Plane level. The ADM at the Control Plane level can monitor the activity in user plane functions such as User Plane UPF gateways. When an anomaly is detected, the ADM at the Control Plane level can send event alert(s) to one or more Security Information Event Management databases (sometimes referred to herein as “SIEM” databases) and/or to other network control functions. The ADM at the Control Plane level can also be able to take corrective action by, for example, archiving the affected User Plane UPF gateway and replacing it with a gateway that has not been altered or infected.

As described herein, various embodiments can provide for one or more of the following benefits: (1) A gateway that detects anomalies in an enterprise setting that affect performance and security (e.g., detecting that abnormal amounts of data are being transferred). In one specific example, if a malicious actor is exfiltrating data, a gateway (according to an embodiment) could detect such activity potentially before such activity would otherwise be detected by a conventional security system; (2) A home-based security gateway that can be deployed at a consumer location. In one example, a gateway (according to an embodiment) can alert a central location if any abnormal activity is detected in any of the user device(s) connected to the gateway. In various examples, such user devices can include connected sensor(s) and/or other IoT (Internet-Of-Things) device(s); (3) Having a central core network anomalies manager that can provide an advantage based upon the visibility that such central core network anomalies manager receives from, e.g., thousands or potentially millions of localized user plane gateways. In various examples, this data can be monetized and potentially sold to data analytics customer(s); and/or (4) Providing of product(s)/service(s) that would ensure (or help to ensure) the security and performance of video transmissions to consumer and/or enterprise locations. For example, streaming services could use one or more gateways (according to an embodiment) to control transmission of video traffic specifically to each location.

As described herein, various embodiments can provide for a 5G CUPS Network Anomalies Manager (which can facilitate, for example, network anomalies detection in 5G CUPS network(s)).

As described herein, various embodiments can provide a mechanism to: (a) establish a baseline regarding communications (e.g., a baseline regarding network traffic); and (b) determine abnormality relative to the baseline.

As described herein, various embodiments can provide a mechanism to: (a) establish a pattern regarding communications (e.g., a pattern regarding network traffic); and (b) determine abnormality relative to the pattern.

As described herein, various embodiments can utilize 5G architecture without hardware probes (this can be done, for example, because in various embodiments traffic (user/control) is separated).

As described herein, various embodiments can (e.g., after anomaly detection) send one or more alerts.

As described herein, various embodiments can operate in the context of one or more mobile devices (e.g., anomalies can be detected and/or repaired regarding traffic traveling to and/or from one or more mobile devices)

As described herein, various embodiments can operate in the context of a factory having outward-facing network connectivity and one or more machines (e.g., IoT machines) in the factory that communicate with the outside network.

As described herein, various embodiments can operate in the context of: (a) a UPF having an interface (user plane) to the Internet; and (b) a centralized manager having an interface (control plane) to a core network (e.g., 5G core network).

As described herein, various embodiments can provide an ADM (Anomalies Detection Manager) that builds a repository of what is considered normal behavior for each of a plurality of IP (Internet Protocol) address (e.g., builds a repository of what is considered normal traffic flowing to and from each of a plurality of monitored IP address).

As described herein, various embodiments can provide an ADM (Anomalies Detection Manager) that can look at traffic headers to determine behavior that is normal or that is not normal.

As described herein, various embodiments can utilize a router as a UPF.

As described herein, various embodiments can operate in the context of one or more centralized devices.

As described herein, various embodiments can provide an ADM (Anomalies Detection Manager) that can provision one or more other devices (e.g., a gateway device, an end user device). In one example, the ADM can have a provisioning interface that allows one or more other devices (e.g., a gateway device, an end user device) to communicate with the ADM and instruct the ADM as to what action to take and/or to receive instructions from the ADM.

As described herein, various embodiments can provide for external provisioning (e.g., external provisioning of a gateway device and/or an end user device).

As described herein, various embodiments can use the existing 5G architecture to interface with a core carrier.

As described herein, various embodiments can operate in the context of a home, an office, a factory, or any combination thereof.

As described herein, an entity that manages a UPF can detect one or more anomalies in a home, in an office, in a factory, or in any combination thereof.

As described herein, various embodiments can operate in the context of a UPF that can see video traffic and that can detect abnormal behavior with regard to such video traffic. In one example, the video traffic going into a home can be monitored. In another example, monitoring of the video traffic can be on a periodic basis (e.g., hour by hour basis). In another example, the monitoring of the video traffic can result in a determination of a “low” level of video traffic, a “normal” level of video traffic, or a “high” level of video traffic. In one example, an Anomalies Detection Manager can detect too much traffic (e.g., too much video traffic) and then inform a UPF associated with such high level of traffic (e.g., a UPF on a gateway) that the condition is abnormal. The informing of the UPF (e.g., the UPF on the gateway) can flag the abnormality and/or instruct the UPF (e.g., the UPF on the gateway) to interface with a billing system (e.g., to bill a customer for excess traffic).

As described herein, various embodiments can operate in the context of a UPF on a mobile device.

As described herein, various embodiments can provide a home hardware box with a UPF.

As described herein, various embodiments can operate in the context of a mobile device that is in bi-directional communication with a home UPF. The home UPF (in various embodiments) is in turn in bi-directional communication with the Internet (e.g., via functionality similar to Wi-Fi). The Internet (in various embodiments) is in turn in bi-directional communication with a core network.

As described herein, various embodiments can operate in the context of a core network that includes access mobility functionality and session management functionality.

As described herein, an Anomalies Detector can be part of a UPF residing in an enterprise (see, e.g., elements 202/204 of FIG. 2A and elements 208/210 of FIG. 2A).

As described herein, various embodiments can utilize UPFs that reside in distributed locations and that interface with the 5G Core. In one specific example, the interface with each of the UPFs can be the SMF of the 5G Core. In other examples, the interface with each of the UPFs can be one or more other network elements defined in the 5G Core.

As described herein, a UPF (that can include an Anomalies Detector embedded therein) can transfer data to one or more external networks. In various examples, a UPF can carry out communications (e.g., that include sending of one or more detected anomalies) with a control plane gateway (such as an SMF).

As described herein, in various embodiments a UPF has a control plane interface to the core network. In one example (as provided for under current 3GPP specifications) a UPF “talks to” (communicates with) the Session Management Function or SMF. This communication can be required to establish the traffic flow. The UPF may also “talk to” (communicate with) one or more gNodeB's (cell sites) once the control plane setup has been completed.

In various embodiments, a UPF “talks to” (communicates with) one or more 5G Core Network Elements (e.g., SMF) in order to transmit indications of anomalies. These anomalies can then be recorded and managed by an Anomalies Detection Manager (see, e.g., element 212 of FIG. 2A).

As described herein, in various embodiments each UPF can receive its control information from the 5G Core SMF. Once control plane setup functions have been completed, each UPF can receive data from the cell sites and can send the data to one or more external networks. If a given UPF detects one or more anomalies, then these one or more anomalies can be reported by the given UPF to the Control Plane function residing in the 5G Core. In other words, in various embodiments each UPF can send to the SMF 5G Core function an indication of the respective one or more detected anomalies (in one example, the SMF 5G Core function can in turn forward the indication of the one or more anomalies to an Anomalies Detection Manager).

As described herein, various embodiments can operate in the context of a 5G CUPS network (generally, it is accepted that Release 15 of 3GPP is 5G). In other embodiments, operation can be in the context of CUPS as introduced in Release 13 and/or Release 14 of 3GPP (for example, in Release 14 LTE, there are control plane MME and control plane S-Gateways and user plane S-Gateways and P-Gateways; thus, CUPS is not exclusive to 5G). In other embodiments, operation can be in the context of CUPS as introduced in Release 16 and/or 17 (which are 5G) of 3GPP. In other embodiments, operation can be in the context of Release 18 (which is considered 6G) of 3GPP and is expected to be approved in the future.

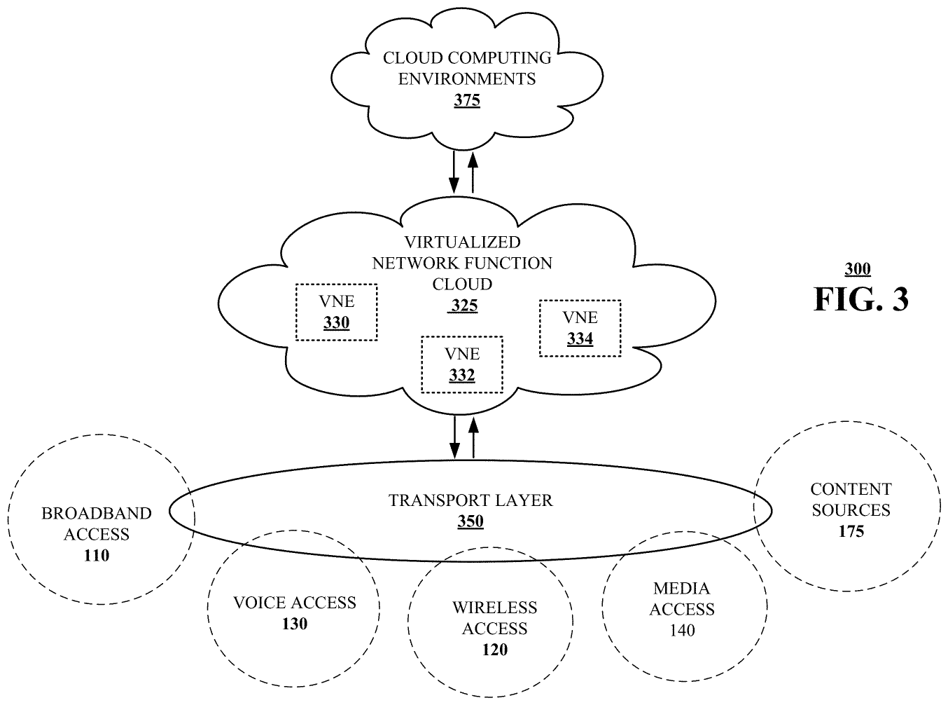

Referring now to FIG. 3, a block diagram 300 is shown illustrating an example, non-limiting embodiment of a virtualized communication network in accordance with various aspects described herein. In particular, a virtualized communication network is presented that can be used to implement some or all of the subsystems and functions of system 100, some or all of the subsystems and functions of system 200, and/or some or all of the methods 2000, 2001, 2002 presented in FIGS. 1, 2A, 2B, 2C, and 2D. For example, virtualized communication network 300 can facilitate in whole or in part network anomalies management (e.g., network anomalies detection and/or repair).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

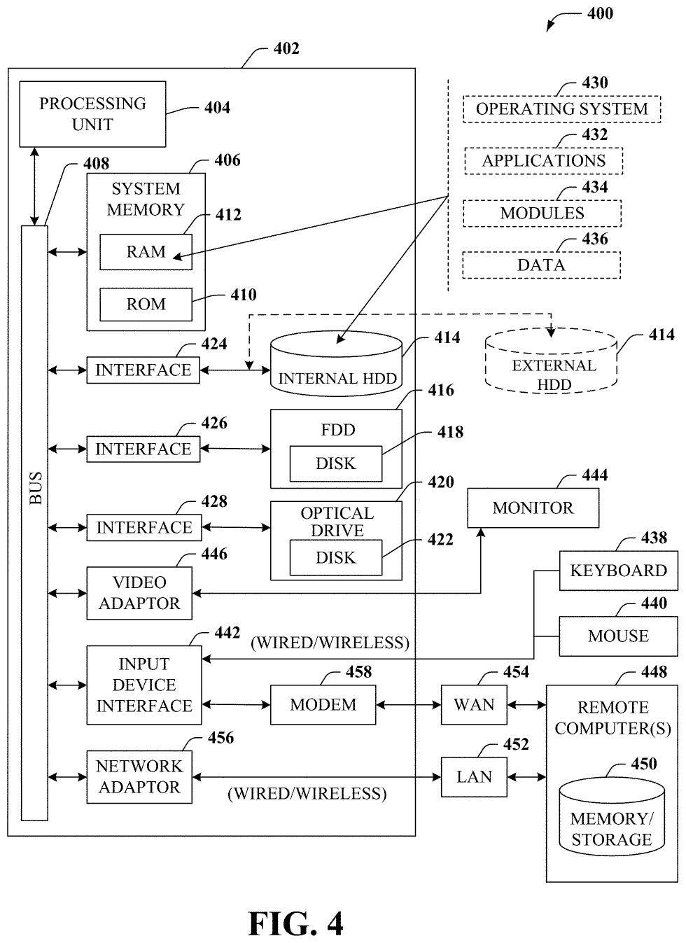

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part network anomalies management (e.g., network anomalies detection and/or repair).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part network anomalies management (e.g., network anomalies detection and/or repair). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

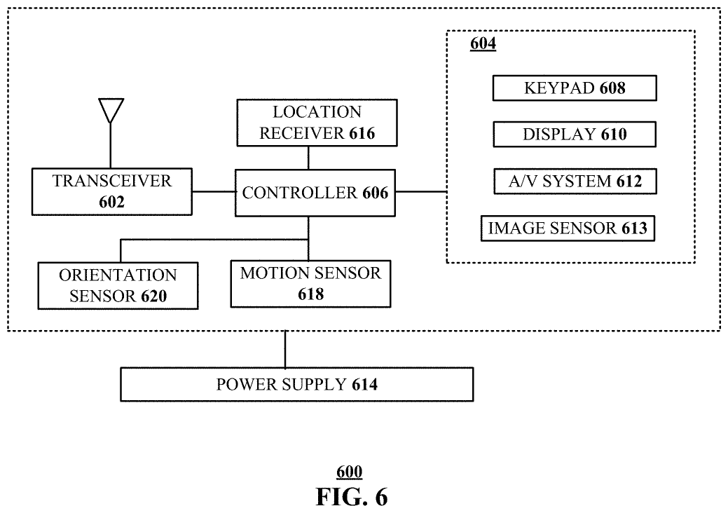

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part network anomalies management (e.g., network anomalies detection and/or repair).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically managing network anomalies) can employ various AI-based schemes for carrying out various embodiments thereof. Moreover, the classifier can be employed to determine a ranking or priority of each network anomaly. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to management of network anomalies, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining first data from a first gateway device located at a first location, the first gateway device having had first network traffic pass therethrough, the first data having been generated by a first user plane function that is operative on the first gateway device, the first data being indicative of a first network traffic anomaly associated with the first network traffic that had passed through the first gateway device, and the first network traffic anomaly having been detected by the first user plane function;
determining via a control plane function, based at least in part upon the first data, whether a corrective action should be taken as a result of the first network traffic anomaly that is indicated by the first data, the determining resulting in a determination; and
responsive to the determination being that the corrective action should be taken as the result of the first network traffic anomaly that is indicated by the first data, sending via the control plane function an instruction to the first user plane function, the instruction that is sent to the first user plane function instructing the first user plane function to take the corrective action with respect to the first network traffic anomaly.

2. The device of claim 1, wherein:
the first data is obtained by a session management function of a core network;
the session management function of the core network has an interface to an anomalies detection manager;
the session management function sends the first data to the anomalies detection manager via the interface;
the anomalies detection manager makes the determination; and
the anomalies detection manager sends information indicative of the determination to the session management function via the interface.

3. The device of claim 1, wherein the instruction to take the corrective action comprises an instruction to terminate current communications with a particular internet protocol (IP) address.

4. The device of claim 1, wherein the operations further comprise:
responsive to the determination being that the corrective action should be taken as the result of the first network traffic anomaly that is indicated by the first data, sending an output to a graphical user interface, the output comprising an indication that the corrective action should be taken as the result of the first network traffic anomaly.

5. The device of claim 1, wherein the control plane function is operative on a 5th generation (5G) Control User Plane Separation (CUPS) network.

6. The device of claim 1, wherein the processing system is operative on a 5th generation (5G) Control User Plane Separation (CUPS) network.

7. The device of claim 6, wherein the processing system comprises one or more servers operative on the 5G CUPS network.

8. The device of claim 1, wherein:
the operations further comprise obtaining second data from a second gateway device, the second gateway device being located at a second location, the second data being generated by a second user plane function, the second user plane function being operative on the second gateway device, and the second data being indicative of a second network traffic anomaly associated with second network traffic that has passed through the second gateway device;
the first location comprises a first home location, a first enterprise location, or any first combination thereof; and
the second location comprises a second home location, a second enterprise location, or any second combination thereof.

9. The device of claim 8, wherein:
the first data is indicative of a first internet protocol (IP) address; and
the second data is indicative of a second internet protocol (IP) address.

10. The device of claim 9, wherein the determining by the control plane function whether the corrective action should be taken as the result of the first network traffic anomaly that is indicated by the first data further comprises making the determination based at least in part upon whether the first IP address is a same IP address as the second IP addresses.

11. The device of claim 8, wherein:
the first data is indicative of a first bandwidth usage; and
the second data is indicative of a second bandwidth usage.

12. The device of claim 11, wherein the determining by the control plane function whether the corrective action should be taken as the result of the first network traffic anomaly that is indicated by the first data further comprises making the determination based at least in part upon whether the first bandwidth usage is greater, by a threshold value, than the second bandwidth usage.

13. The device of claim 12, wherein the threshold value is above zero.

14. The device of claim 11, wherein:
the operations further comprise determining, based upon the second bandwidth usage, an average bandwidth usage; and
the determining by the control plane function whether the corrective action should be taken as the result of the first network traffic anomaly that is indicated by the first data comprises determining that the first bandwidth usage is greater, by a threshold value, than the average bandwidth usage.

15. The device of claim 14, wherein the threshold value is above zero.

16. A non-transitory machine-readable medium comprising executable instructions that, when executed by a processing system including a processor, facilitate performance of operations, the operations comprising:
obtaining respective data from each of a plurality of gateway devices, each of the gateway devices being located at a respective location, each of the gateway devices having had respective network traffic pass therethrough the respective data from each of the gateway devices having been generated by a respective user plane function, each of the user plane functions being operative on a respective one of the gateway devices, the respective data from each of the gateway devices being indicative of a respective network traffic anomaly associated with respective network traffic that had passed through a respective one of the gateway devices, and each network traffic anomaly having been detected by a respective one of the user plane functions;
determining for a first one of the gateway devices via a control plane function, based at least in part upon some or all of the data from the gateway devices, whether a corrective action should be taken as a result of a first network traffic anomaly that is indicated by respective data associated with the first one of the gateway devices, the determining resulting in a determination; and
performing an action in response to the determination being that the corrective action should be taken, the action comprising:
sending via the control plane function to a first user plane function on the first one of the gateway devices an instruction to take the corrective action;
sending an output to a graphical user interface, the output comprising an indication that the first network traffic comprises anomalous network traffic; or
any combination thereof.

17. The non-transitory machine-readable medium of claim 16, wherein the corrective action comprises:
terminating current communications with a particular internet protocol (IP) address; and
prohibiting future communications with the particular (IP) address.

18. A method comprising:
transferring, by a processing system of a first gateway device including a processor, first network traffic, the first gateway device being located at a first location, the first network traffic being used by a first user plane function that is operative on the first gateway device to generate anomaly data that is indicative of a first network traffic anomaly associated with the first network traffic that has passed through the first gateway device;
sending, by the processing system, the anomaly data to a server associated with a 5th generation (5G) Control User Plane Separation (CUPS) network;
receiving, by the processing system, an instruction signal from the server, the instruction signal having been generated by the server in response to a determination that the instruction signal should be sent to the first gateway device, the determination being made via a control plane function, the determination being based at least in part upon the anomaly data and other data, the other data being obtained by the server from a plurality of other gateway devices, each of the other gateway devices being located at a respective other location, each of the other data being generated by a respective other user plane function, each other user plane function being operative on a respective one of the other gateway devices, and each of the other data being indicative of a respective other network traffic anomaly associated with respective network traffic through a respective other gateway device; and
responsive to receipt of the instruction signal, taking an action by the processing system to adjust the first network traffic anomaly.

19. The method of claim 18, wherein the taking the action to adjust the first network traffic anomaly comprises:
terminating current communications with a first particular internet protocol (IP) address;
prohibiting future communications with a second particular internet protocol (IP) address; or
any combination thereof.

20. The method of claim 19, wherein the first particular IP address is a same address as the second particular IP address.
